(19) United States
(12) Patent Application Publication
(10) Pub. No.: US 2007/0180453 A1
(43) Pub. Date: Aug. 2, 2007

(54) On demand application scheduling in a heterogeneous workload environment

(75) Inventors: Michael J. Burr, Cary, NC (US); Erik A. Daughtrey, Durham, NC (US); Charles P. Fricano, Raleigh, NC (US); Daniel J. Labrecque, Chapel Hill, NC (US); Gabriel G. Montero, Chapel Hill, NC (US); Sajan Sankaran, Raleigh, NC (US); Michael J. Spreitzer, Croton-on-Hudson, NY (US); Malgorzata Steinder, Leonia, NJ (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/340,937

(22) Filed: Jan. 27, 2006

(51) Int. Cl. G06F 9/46

(52) U.S. Cl. 718/105

(57) ABSTRACT

Embodiments of the present invention address deficiencies of the art in respect to deploying heterogeneous workloads in separate resource pools and provide a method, system and computer program product for on-demand application scheduling in a heterogeneous environment. In one embodiment of the invention, a method for balancing nodal allocations in a resource pool common to both transactional workloads and long running workloads can include parsing a service policy for both transactional workloads and also long running workloads. An allocation of nodes for a common resource pool for the transactional and long running workloads can be determined to balance performance requirements for the transactional workloads and long running workloads specified by the service policy. Subsequently, the determined allocation can be applied to the common resource pool.

### BACKGROUND OF THE INVENTION

1. Field of the Invention

The present invention relates to application scheduling and more particularly to service policy driven transaction workload scheduling.

2. Description of the Related Art

Application server clusters have become common in the field of high-availability and high-performance computing. Application cluster-based systems exhibit three important and fundamental characteristics or properties: reliability, availability and serviceability. Each of these features are of paramount importance when designing a robust clustered system. Generally, a clustered system consists of multiple application server instances grouped together in a server farm of one or more server computing nodes that are connected over high-speed network communicative linkages. Each application server process in the application cluster can enjoy access to memory, possibly disk space and the facilities of a host operating system.

Among the many challenges faced by those who manage the capacity and performance of a clustered system is the allocation of network resources for consumption by a particular application or workload. Referred to as application scheduling, network resources in a cluster can be managed through agents known as workload managers. The workload managers can optimally assign different network resources within endpoint containers to handle selected workloads in an application. In many cases, workload managers can adjust the assignment of network resources based upon performance metrics measured through systems management components in the clustered system.

Workloads can vary from real-time transactions to batch processed transactions. For transactional workloads, workload performance can be measured in terms of response time. By comparison, in batch processing, workload performance can be measured in terms of the maximum time in a queue. Service policies can specify the desired performance characteristics for workloads and workload managers can rely upon configured service policies in order to optimally allocate resources in a node to satisfy a workload request.

Long-running workloads are similar to batch processed transactions in that real-time performance is not expected. As such, when application scheduling long-running workloads, performance also is measured in terms of maximum time in a queue. Thus, while the performance criteria of long-running workloads are measured similarly to batch processed workloads, the performance criteria for long-running workloads differ from that of real-time transaction workloads. Consequently, application scheduling logic for long-running workloads also differs from the application scheduling logic for real-time transaction workloads.

It will be apparent to the skilled artisan, then, that application scheduling in a heterogeneous workload environment can be complicated. To address the heterogeneous workload environment, data centers often separate traditional transactional workloads from long running workloads by deploying each into separate resource pools. As a result, the costs of establishing and maintaining the data center can be extensive as much logic and infrastructure can be duplicated for each workload type. Yet, oftentimes, resources within a resource pool can remain idle were workloads are light.

### BRIEF SUMMARY OF THE INVENTION

Embodiments of the present invention address deficiencies of the art in respect to deploying heterogeneous workloads in separate resource pools and provide a novel and non-obvious method, system and computer program product for on-demand application scheduling in a heterogeneous environment. In one embodiment of the invention, a method for balancing nodal allocations in a resource pool common to both transactional workloads and long running workloads can include parsing a service policy for both transactional workloads and also long running workloads. An allocation of nodes for a common resource pool for the transactional and long running workloads can be determined to balance performance requirements for the transactional workloads and long running workloads specified by the service policy. Subsequently, the determined allocation can be applied to the common resource pool.

In one aspect of the embodiment, parsing a service policy for both transactional workloads and also long running workloads can include parsing the service policy to determine a maximum response time for transactional workloads and a maximum queue time for long running workloads. In another aspect of the embodiment, the nodal allocation determination can include measuring performance data for received transactional workloads and long running workloads in the common resource pool, detecting a performance deficiency with respect to the service policy, and computing a number of nodes to be added to the common resource pool to ameliorate the performance deficiency.

Also, the nodal allocation determination can include measuring performance data for received transactional workloads and long running workloads in the common resource pool, determining the satisfaction of the performance requirements of the service policy by the common resource pool, detecting excess capacity in the common resource pool, and computing a number of nodes to be removed from the common resource pool to remove the excess capacity while maintaining the performance requirements of the service policy. Finally, the nodal allocation determination can include comparing utility values for received transactional workloads and long running workloads in the common resource pool, and determining nodal allocations in the common resource pool based upon the comparison of the utility values.

In another embodiment of the invention, a data processing system for balancing nodal allocations in a resource pool common to both transactional workloads and long running workloads can include a router configured for communicative coupling to one or more requesting clients over a computer communications network. The data processing system also can include a workload manager for a resource pool common to both transactional workloads and long running workloads. Finally, the data processing system can include a balancer. The balancer can include program code enabled to specify a nodal configuration for the resource pool to achieve performance requirements specified by a service policy both for the transactional workloads and also for the long running workloads.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of an application scheduling system in a heterogeneous workload environment; and,

FIG. 2 is a flow chart illustrating a process for scheduling heterogeneous workloads in a common resource pool in an application scheduling system.

### DETAILED DESCRIPTION OF THE INVENTION

Embodiments of the present invention provide a method, system and computer program product for scheduling heterogeneous workloads in a common resource pool in an application scheduling system. In accordance with an embodiment of the present invention, the allocation of resource nodes in a resource pool can account for both the service policy for transactional workloads and also the service policy for long running workloads. Specifically, a balancer can direct a workload manager to adjust a corresponding nodal configuration in a resource pool in which both transaction and long running workloads can be processed. The adjustment of the nodal configurations can account both for the need for the transactional workloads to execute within a prescribed period of time, and also for the need of the long running workloads to remain in a queue only for a threshold period of time.

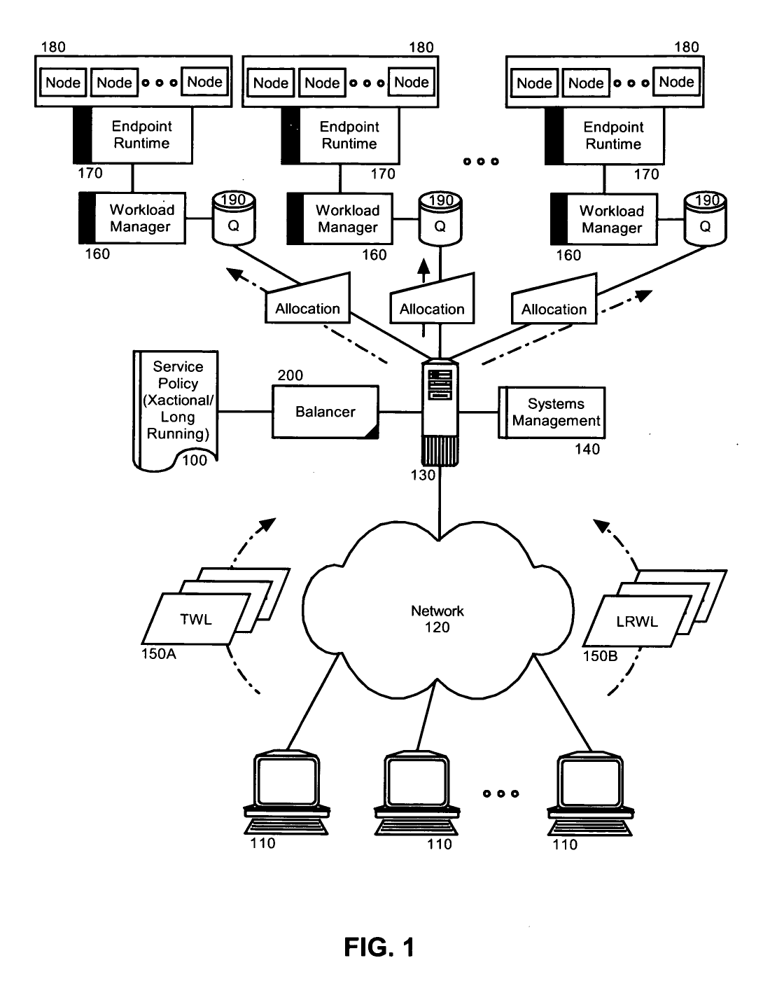

In further illustration, FIG. 1 is a schematic illustration of an application scheduling system in a heterogeneous workload environment. The application scheduling system can include a workload router 130 coupled to one or more client requestors 110 over a computer communications network 120. The workload router 130 can be configured to route both transactional workloads 150A and long running workloads 150B to nodes in one or more resource pools 180. Within the nodes in the resource pools 180, the workloads 150A, 150B can be processed in order to meet respective performance goals defined with a service policy 100. For instance, the performance goals defined with the service policy 100 can specify a minimum response time for transactional workloads and a threshold time period in which long running workloads are to remain in a queue 190 for a workload manager 160.

Notably, a balancer 200 can be communicatively coupled both to the router 130 and the service policy 100. The balancer 200 can include program code enabled to provide nodal allocation configurations to the workload managers 160 which in turn can apply received nodal allocation configurations to endpoint runtime containers 170 managing respective ones of the resource pools 180. Specifically, each of the nodal allocation configurations specifies the number of nodes in a corresponding one of the resource pools 180. Nodes can be added and removed at the discretion of the balancer 200 so as to achieve the service goals for both transactional workloads and long running workloads within the same one of the resource pools 180 as specified by the service policy 100.

More specifically, the balancer 200 can receive input from the transactional workload side managing the transactional workloads, and the long running workload side managing the long running workloads. The balancer can make a decision on rebalancing via a post to a shared state system. In this regard, the transactional workload side can produce a utility value for each application request type and can use the utility value to determine when new application instances are needed to support new workloads. Similarly, the long running workload side can calculate a utility value for each application based on policy. The utility value for the long running workload side can indicate how well an application is meeting its service goals.

It will be recognized by the skilled artisan that, although the utility values for each of the transactional workloads and long running workloads are calculated differently, the utility values generated by both sets of components are comparable. As such, the balancer 200 can compare the utility values to determine how well each side of the heterogeneous system is performing. Whenever balancing is required, the balancer 200 can change the ownership of a node state in a shared area of a node. The node states can include “WEB”, “LR”, “Transistion-LR-To-WEB”, and “Transisiton-WEB-to-LR”. Each of the transactional workload side and the long running workload side can consult the shared state to decide what nodes they have available for their respective function within each node group.

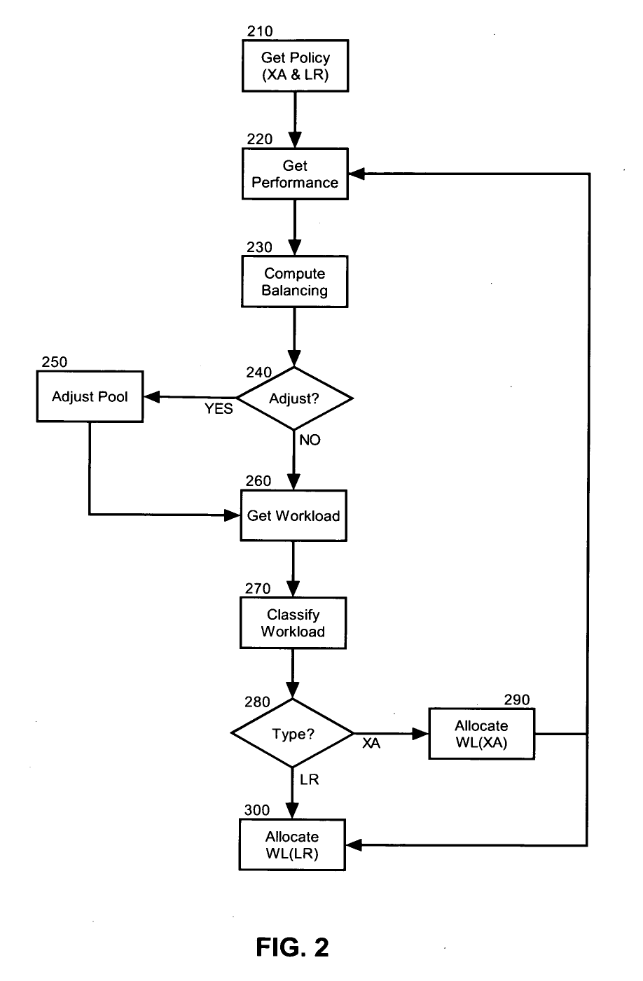

In further illustration, FIG. 2 is a flow chart illustrating a process for scheduling heterogeneous workloads in a common resource pool in application scheduling system. Beginning in block 210, one or more service policies can be retrieved, which collectively define a service policy for both transactional workloads and long running workloads in a common resource pool. The service policy for both the transactional workloads and the long running workloads can specify, for example, the maximum acceptable response time for a transactional workload and the time permitted for a long running workload to remain in a queue awaiting processing by a node in the common resource pool.

In block 220, the performance of the transactional workloads and the long running workloads sharing a common resource pool can be measured and, in consequence of the measurement, a nodal allocation can be computed so as to balance the requirements of the transactional workloads and the long running workloads in the common resource pool as specified by the service policy. In decision block 240, it can be determined whether or not the nodal allocation in the resource pool requires adjustment.

If so, in block 250 a new nodal allocation can be computed and the common resource pool can be adjusted accordingly. For instance, one or more nodes can be removed from the common resource pool, or one or more nodes can be added to the common resource pool. In any event, in block 260, a workload can be received for processing and in block 270, the workload can be classified as one of a transactional workload and a long running workload. In decision block 280, if the type is one of a transactional workload, in block 290 the workload can be passed to a workload manager for the common resource pool to be handled as a transactional workload. Otherwise, in block 300 the workload can be passed to the workload manager for the common resource pool to be handled as a long running workload.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for balancing nodal allocations in a resource pool common to both transactional workloads and long running workloads, the method comprising:
parsing a service policy for both transactional workloads and also long running workloads;
determining an allocation of nodes for a common resource pool for the transactional and long running workloads to balance performance requirements for the transactional workloads and long running workloads specified by the service policy; and,
applying the determined allocation to the common resource pool.

2. The method of claim 1, wherein parsing a service policy for both transactional workloads and also long running workloads, comprises parsing the service policy to determine a maximum response time for transactional workloads and a maximum queue time for long running workloads.

3. The method of claim 1, wherein determining an allocation of nodes for a common resource pool for the transactional and long running workloads to balance performance requirements for the transactional workloads and long running workloads specified by the service policy, comprises:
measuring performance data for received transactional workloads and long running workloads in the common resource pool;
detecting a performance deficiency with respect to the service policy; and,
computing a number of nodes to be added to the common resource pool to ameliorate the performance deficiency.

4. The method of claim 1, wherein determining an allocation of nodes for a common resource pool for the transactional and long running workloads to balance performance requirements for the transactional workloads and long running workloads specified by the service policy, comprises:
measuring performance data for received transactional workloads and long running workloads in the common resource pool;
determining the satisfaction of the performance requirements of the service policy by the common resource pool;
detecting excess capacity in the common resource pool; and,
computing a number of nodes to be removed from the common resource pool to remove the excess capacity while maintaining the performance requirements of the service policy.

5. The method of claim 1, wherein determining an allocation of nodes for a common resource pool for the transactional and long running workloads to balance performance requirements for the transactional workloads and long running workloads specified by the service policy, comprises:
comparing utility values for received transactional workloads and long running workloads in the common resource pool; and,
determining nodal allocations in the common resource pool based upon the comparison of the utility values.

6. A data processing system for balancing nodal allocations in a resource pool common to both transactional workloads and long running workloads, the data processing system comprising:
a router configured for communicative coupling to one or more requesting clients over a computer communications network;
a workload manager for a resource pool common to both transactional workloads and long running workloads; and,
a balancer comprising program code enabled to specify a nodal configuration for the resource pool to achieve performance requirements specified by a service policy both for the transactional workloads and also for the long running workloads.

7. The data processing system of claim 6, further comprising an endpoint runtime container communicatively coupled to the workload manager and configured to add and remove nodes from the common resource pool as directed by the workload manager.

8. The data processing system of claim 6, further comprising systems management components coupled to the balancer and configured to provide access to performance data for executing ones of the transactional workloads and executing ones of the long running workloads.

9. A computer program product comprising a computer usable medium having computer usable program code for balancing nodal allocations in a resource pool common to both transactional workloads and long running workloads, the computer program product including:
computer usable program code for parsing a service policy for both transactional workloads and also long running workloads;
computer usable program code for determining an allocation of nodes for a common resource pool for the transactional and long running workloads to balance performance requirements for the transactional workloads and long running workloads specified by the service policy; and,
computer usable program code for applying the determined allocation to the common resource pool.

10. The computer program product of claim 9, wherein the computer usable program code for parsing a service policy for both transactional workloads and also long running workloads, comprises computer usable program code for parsing the service policy to determine a maximum response time for transactional workloads and a maximum queue time for long running workloads.

11. The computer program product of claim 9, wherein the computer usable program code for determining an allocation of nodes for a common resource pool for the transactional and long running workloads to balance performance requirements for the transactional workloads and long running workloads specified by the service policy, comprises:
computer usable program code for measuring performance data for received transactional workloads and long running workloads in the common resource pool;
computer usable program code for detecting a performance deficiency with respect to the service policy; and,
computer usable program code for computing a number of nodes to be added to the common resource pool to ameliorate the performance deficiency.

12. The computer program product of claim 9, wherein the computer usable program code for determining an allocation of nodes for a common resource pool for the transactional and long running workloads to balance performance requirements for the transactional workloads and long running workloads specified by the service policy, comprises:
computer usable program code for measuring performance data for received transactional workloads and long running workloads in the common resource pool;
computer usable program code for determining the satisfaction of the performance requirements of the service policy by the common resource pool;
computer usable program code for detecting excess capacity in the common resource pool; and,
computer usable program code for computing a number of nodes to be removed from the common resource pool to remove the excess capacity while maintaining the performance requirements of the service policy.

13. The computer program product of claim 9, wherein the computer usable program code for determining an allocation of nodes for a common resource pool for the transactional and long running workloads to balance performance requirements for the transactional workloads and long running workloads specified by the service policy, comprises:
computer usable program code for comparing utility values for received transactional workloads and long running workloads in the common resource pool; and,
computer usable program code for determining nodal allocations in the common resource pool based upon the comparison of the utility values.
